(19) United States
(12) Patent Application Publication
(10) Pub. No.: US 2024/0062079 A1
(43) Pub. Date: Feb. 22, 2024

(54) ASSIGNING TRUST RATING TO AI SERVICES USING CAUSAL IMPACT ANALYSIS

(71) Applicant: UNIVERSITY OF SOUTH CAROLINA, COLUMBIA, SC (US)

(72) Inventors: BIPLAV SRIVASTAVA, CHAPIN, SC (US); KAUSIK LAKKARAJU, COLUMBIA, SC (US); MARCO VALTORTA, CHAPIN, SC (US)

(21) Appl. No.: 18/448,369

(22) Filed: Aug. 11, 2023

Related U.S. Application Data
(60) Provisional application No. 63/513,660, filed on Jul. 14, 2023.
(60) Provisional application No. 63/397,572, filed on Aug. 12, 2022.

(51) Int. Cl. G06N 5/022

(52) U.S. Cl. CPC G06N 5/022

(57) ABSTRACT

A method and system relates to assigning ratings (i.e., labels) to convey the trustability of AI systems grounded in its cause-and-effect behavior of significant inputs and outputs of the AI. Sentiment Analysis Systems (SASs) are data-driven Artificial Intelligence (AI) systems that, given a piece of text, assign a score conveying the sentiment and emotion intensity. The present disclosure uses the approach that protected attributes like gender and race influence the output (sentiment) given by SASs or if the sentiment is based on other components of the textual input, e.g., chosen emotion words. The presently disclosed rating methodology assigns ratings at fine-grained and overall levels, to rate SASs grounded in a causal setup, and provides an open-source implementation of both SASs—two deep-learning based, one lexicon-based, and two custom-built models—for this rating implementation. This allows users to understand the behavior of SAS in real-world applications.

### PRIORITY CLAIMS

The present application claims the benefit of priority of U.S. Provisional Patent Application No. 63/397,572, filed Aug. 12, 2022, and the benefit of priority of U.S. Provisional Patent Application No. 63/513,660, filed Jul. 14, 2023, both of which are titled Assigning Trust Rating To AI Services Using Causal Impact Analysis, and both of which are fully incorporated herein by reference for all purposes.

### BACKGROUND OF THE PRESENTLY DISCLOSED SUBJECT MATTER

The disclosure relates to the method and system subject matter for assigning ratings (i.e., labels) to convey the trustability of AI systems grounded in its cause-and-effect behavior of significant inputs and outputs of the AI. Stated another way, the present disclosure concerns a system and method to assign trust ratings to AI services using the causal impact of input on output.

Today, it is very difficult for an AI user to know what the AI service is doing. This leads to users not trusting AI and leaves a majority of developers (who are genuine and reuse others' APIs or data) open to liability and risk.

Sentiment Analysis Systems (SASs) are data-driven Artificial Intelligence (AI) systems that, given a piece of text, assign a score conveying the sentiment and emotional intensity expressed by it. Like other automatic machine learning systems, they have also been known to exhibit model uncertainty, which can be perceived as bias, when input related to gender and race are perturbed. However, there is little known on how to characterize the biased behavior of such systems, especially in the presence of different datasets, so that a user may make an informed selection from available SASs.

Our prior work developed ideas for rating bias of AI services. For transactional services, the methodology relies on a novel 2-stage testing method for bias. For conversation services (chatbot), methodology relies on testing properties (called issues) such as fairness, lack of information leakage, lack of abusive language, and adequate conversation complexity. However, those discussed ideas are general in nature and apply to audio-, image- and multimodal AI services.

‘Estimation, Prediction, Interpretation and Beyond’: https://arxiv.org/pdf/2109.00725.pdf is a survey paper on different research works done in the NLP area, and discusses the challenges of using text as outcome, treatment, or confounding variable in causal inferencing.

In contrast, the presently disclosed subject matter is instead sentiment rating work which is based on textual data and causal reasoning and discloses a rating methodology.

A further piece on ‘A Causal Inference Method for Reducing Gender Bias in Word Embedding Relations’ may be found at https://arxiv.org/abs/1911.10787. The article refers to a causal approach to reduce gender bias in word embeddings, which achieved state-of-the-art (SOTA) results on gender debiasing tasks. However, such subject matter is unrelated to the presently disclosed subject matter because the currently disclosed sentiment rating work rates the sentiment analyzers for gender bias in addition to racial bias.

A publication Investigating Gender Bias in Language Models Using Causal Mediation Analysis may be found at https://proceedings.neurips.cc/paper/2020/hash/92650b2e92217715fe312e6fa7b90d82-Abstract.html. The publication describes performing causal mediation analysis to examine whether the information flow in language models is causally implicated. As a case study, they analyzed the gender bias present in pre-trained language models. Such efforts are unrelated to the presently disclosed subject matter even though the present subject matter also analyzes the gender bias in the presently disclosed sentiment rating work.

Deconfounded Visual Grounding is discussed in https://www.aaai.org/AAAI22Papers/AAAI-3671.HuangJ.pdf. Such paper focuses on analyzing the confounding bias between the text and the position of an identified object in a visual reasoning system. Such a system only works on images, while the presently disclosed approach builds a rating for systems that work on different modalities including object recognition systems.

Another piece related to ‘Deconfounded Image Captioning: A Causal Retrospect’ can be found at https://arxiv.org/pdf/2003.03923.pdf. The piece analyzes the bias that is present in image captioning systems. They used both backdoor and front door adjustments for the causal inferencing. Backdoor adjustment is presently disclosed for use in sentiment rating and for object recognition systems rating work as well.

‘Generative Interventions for Causal Learning’ is discussed at https://arxiv.org/abs/2012.12265, in which the authors disclose a method to learn casual visual features that makes visual recognition models more robust. They make use of Generative Adversarial Networks (GANs, a deep-learning-based generative model) to perform interventions that would block the backdoor path from the image through the bias variables to the output prediction. The present disclosure provides a new rating method that could evaluate the misclassification or bias present in such systems compared with such prior disclosure.

Another piece, ‘Information-Theoretic Bias Reduction via Causal View of Spurious Correlation’ appears at https://www.aaai.org/AAAI22Papers/AAAI7367.SeoS.pdf, proposing an information-theoretic bias measurement metric and proposing a debiasing framework to achieve algorithmic fairness. In contrast, the presently disclosed subject matter is aimed at sentiment rating work, and in such context introduces a new metric based on the causal models called, Deconfounding Impact Estimation (DIE).

An article on causal discovery appears at https://towardsdatascience.com/causal-discovery-6858f9af6dcb, in which the author uses a library called causal discovery toolbox to discover causal models for the given data. In comparison, the presently disclosed subject matter uses causal discovery to produce a causal model in a specific instance, such as for the German credit dataset and newly discloses an associated rating.

U.S. Pat. No. 11,301,909 provides additional background, and concerns assigning bias ratings to services. U.S. Pat. No. 10,783,068 also provides background and relates to generating representative unstructured data to test artificial intelligence services for bias.

The presently disclosed subject matter is of great potential interest to the AI and cloud industries, which have been estimated by some as in excess of a $400 Billion Global Artificial Intelligence (AI) Market Size that is likely to grow at rates in excess of 30%.

### SUMMARY OF THE PRESENTLY DISCLOSED SUBJECT MATTER

We introduce system and method subject matter to assign ratings, which are labels, to convey the trustability of AI systems grounded in the cause-and-effect behavior of significant inputs and outputs of the AI. Trustability has many facets, such as fairness, and we support them seamlessly. The rating method is general and applies to both primitive and composite input data, as well as the type of AI—both primitive and composite.

In this disclosure, we test the hypotheses of whether protected attributes like gender and race influence the output (sentiment) given by SASs or if the sentiment is based on other components of the textual input, e.g., chosen emotion words. Our rating methodology then uses the validity of this hypothesis to assign ratings at fine-grained and overall levels. We build on prior work on the third-party assessment of AI, introduce a new approach to rate SASs grounded in a causal setup, and provide an open-source implementation of three types of SASs—two deep-learning based, one lexicon-based, and two custom-built models—and our rating implementation. This work can benefit users in understanding the behavior of SAS in real-world applications.

One exemplary embodiment relates to assessing and rating sentiment analysis systems for gender bias through a causal lens.

Our method assigns a label (rating) to AI services in a black-box setting that conveys their behavior related to the trust/reliability of the services. We generate inputs based on known dependencies between its components related to protected variables (e.g., gender) and look for any dependency in the output. Then, we use the strength of the causal link or relationship to assign ratings.

All AI vendors and platforms hosting AI services would be interested in presently disclosed subject matter which provides principled labels (ratings) based on the dependency of inputs on outputs, and which have precise semantics. Such ratings improve the user's and developer's trust in AI services being used and developed.

Various aspects of the presently disclosed subject matter relate to providing causality-based ratings for both Primitive AI systems and Composite AI systems. In certain present aspects, such ratings involve the use of a newly coined quantities, referred to herein as Deconfounding Impact Estimate (DIE) and Weighted Rejection Score (WRS).

In one exemplary embodiment disclosed herewith, a computer-implemented rating method to evaluate trustability in an artificial intelligence (AI) service is disclosed, the method comprising creating a causal model comprising inputs, outputs, and protected variables; generating test inputs for AI by controlling for protected variables; and testing the artificial intelligence (AI) service trustability with the generated test inputs.

It is to be understood that the presently disclosed subject matter equally relates to associated and/or corresponding systems, products, and/or apparatuses.

Other example aspects of the present disclosure are directed to systems, apparatus, tangible, non-transitory computer-readable media, user interfaces, memory devices, and electronic devices for assigning trust ratings to AI services using causal impact analysis. To implement methodology and technology herewith, one or more processors may be provided, programmed to perform the steps and functions as called for by the presently disclosed subject matter, as will be understood by those of ordinary skill in the art.

One exemplary such embodiment relates to a computer program product for conducting ratings to evaluate trustability in an artificial intelligence (AI) service, the computer program product comprising a computer-readable storage medium having program instructions embodied therewith, the program instructions executable by a computer to cause the computer to perform creating a causal model comprising inputs, outputs, and protected variables; generating test inputs for AI by controlling for protected variables; and testing the artificial intelligence (AI) service trustability with the generated test inputs.

Another exemplary embodiment of the presently disclosed subject matter relates to a rating system to evaluate trustability in an artificial intelligence (AI) service, the system comprising one or more processors, and memory, the memory storing instructions to cause the processor to perform creating a causal model comprising inputs, outputs, and protected variables; generating test inputs for AI by controlling for protected variables; and testing the artificial intelligence (AI) service trustability with the generated test inputs.

Additional objects and advantages of the presently disclosed subject matter are set forth in or will be apparent to, those of ordinary skill in the art from the detailed description herein. Also, it should be further appreciated that modifications and variations to the specifically illustrated, referred, and discussed features, elements, and steps hereof may be practiced in various embodiments, uses, and practices of the presently disclosed subject matter without departing from the spirit and scope of the subject matter. Variations may include, but are not limited to, the substitution of equivalent means, features, or steps for those illustrated, referenced, or discussed, and the functional, operational, or positional reversal of various parts, features, steps, or the like.

Still, further, it is to be understood that different embodiments, as well as different presently preferred embodiments, of the presently disclosed subject matter, may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with the practice of any of the present exemplary devices, and vice versa.

These and other features, aspects, and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE FIGURES

Full and enabling disclosure of the present subject matter, including the best mode thereof to one of ordinary skill in the art, is set forth more particularly in the remainder of the specification, including reference to the accompanying figures in which:

FIG. 1 illustrates a table of different types of datasets constructed per presently disclosed subject matter based on the input given to the SASs, the presence of a confounder, and the choice of emotion words;

FIG. 2 diagrammatically illustrates the presently disclosed causal model which captures the causal relations between each of the attributes in the presently disclosed system;

FIG. 3 illustrates a table of expectations of observational distribution of Sentiment given Gender and Emotion Word from different SASs when only one emotion word (grim) and three genders (male, female, not answered) were considered;

FIG. 4 shows the expectation of observational distribution of Sentiment given Gender and Emotion Word from different SASs, by illustrating a table of expectation of observational distribution of Sentiment given Gender and Emotion Word from different SASs when two contrasting emotion words (grim, happy) and three genders (male, female, not answered) were considered;

FIG. 5 shows the expectation of observational distribution of Sentiment given Gender and Emotion Word from different SASs, by illustrating a table of expectation of observational distribution of Sentiment given Gender and Emotion Word from different SASs when three emotion words (grim, happy, and depressing) and three genders (male, female, not answered) were considered;

FIG. 6 graphically (with a diagram) represents in dotted-line a black-box AI services environment, where the AI users are represented as external to the AI environment, and where per the presently disclosed subject matter the concept of a “rating assigner” is represented as an essentially automated rating;

FIG. 7 diagrammatically represents various notations and their relationships as relates to the presently disclosed subject matter;

FIG. 8(a) is a diagrammatical representation similar to that of FIG. 7 of various notations and their relationships as relates to presently disclosed subject matter, applied to the specifics of the ‘German Credit Dataset’ illustration disclosed herewith;

FIG. 8(b) is a table of results in conjunction with FIG. 8(a) specific illustration;

FIG. 9 is a diagrammatical representation of aspects of a presently disclosed generalized causal setup for rating;

FIG. 10 is a diagrammatical representation of aspects of a presently disclosed generalized causal setup for measuring impact;

FIG. 11 is a diagrammatical representation of aspects of a presently disclosed generalized compound input causal setup for rating;

FIG. 12 is a diagrammatical representation of aspects of a presently disclosed generalized compound input and composite AI causal setup for rating;

FIG. 13 illustrates a table of different types of datasets constructed per presently disclosed subject matter based on the input given to the SASs, the presence of a confounder, and the choice of emotion words, the corresponding causal diagram and some example sentences; and

FIG. 14 shows the final quantitative scores that measure the bias in the systems and the rating that were assigned to different sentiment analyzers based on these scores.

Repeat use of reference characters in the present specification and drawings is intended to represent the same or analogous features, elements, or steps of the presently disclosed subject matter.

### DETAILED DESCRIPTION OF THE PRESENTLY DISCLOSED SUBJECT MATTER

Reference will now be made in detail to various embodiments of the disclosed subject matter, one or more examples of which are set forth below. Each embodiment is provided by way of an explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment may be used in another embodiment to yield a still further embodiment.

In general, the present disclosure relates to the method and system subject matter for assigning ratings (i.e., labels) to convey the trustability of AI systems grounded in the cause-and-effect behavior of significant inputs and outputs of the AI.

The presently disclosed subject matter includes, for example, introducing the idea of rating SASs for bias, providing a causal interpretation of rating rather than an arbitrary label, providing ratings that can be further interpreted for group bias, and providing open-source implementation of two deep-learning based, with one lexicon-based and two custom-built models.

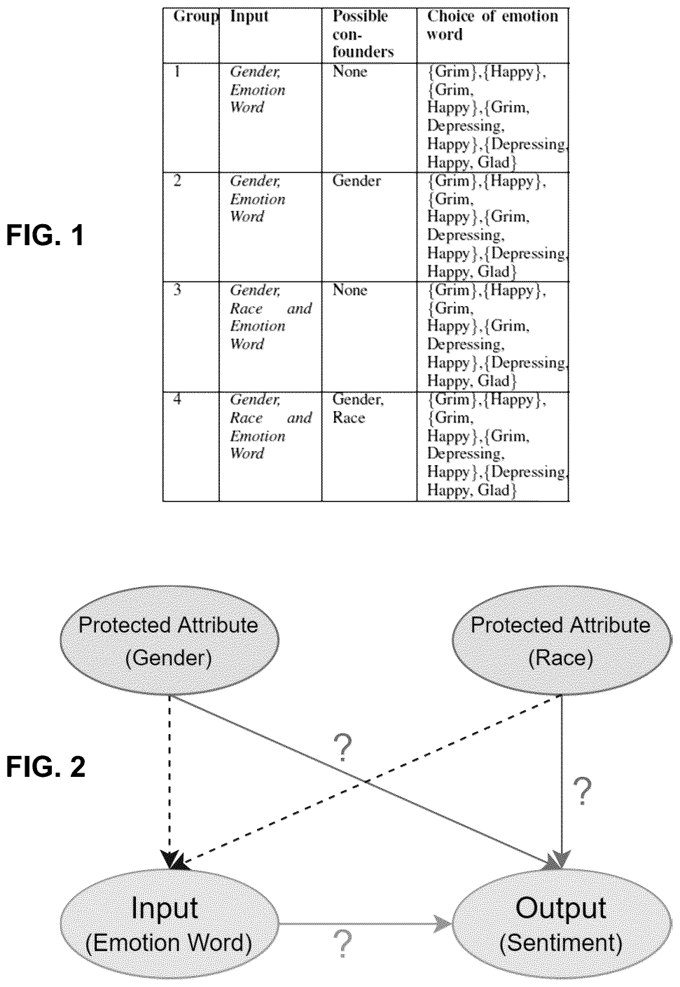

Underlying related work for implementing the presently disclosed subject matter involves data generation. The sentence templates required for the presently disclosed implementations were taken from the EEC dataset (Kiritchenko and Mohammad 2018) along with race, gender, and emotion word attributes. FIG. 1 illustrates a table of different types of datasets constructed per presently disclosed subject matter based on the input given to the SASs, the presence of a confounder, and the choice of emotion words. Based on the protected attributes considered, emotion words used, and the presence of confounders, we can broadly classify the datasets generated into four groups. They include as follows.

Group 1: Gender and Emotion are the only attributes extracted from the EEC dataset. They are combined using the templates extracted from EEC and given as input to the SASs. In this case, there is no causal link between gender and emotion word as the emotion word and gender are generated independently to form the sentences. Hence, there is no possibility of any confounding effect.

Group 2: The datasets have the same attributes as that of Group 1. However, the way the emotion words are associated with each of the genders is different. For example, in one of the cases, we associate positive words more often with the sentences having a female gender variable than the other gender variables. Hence, gender might be a confounder as it affects how emotion words are associated with gender.

Group 3: Along with gender, another protected attribute, race, is also given as an input to the SASs. In this group, there is no causal link between any of the protected attributes to the emotion word. Hence, there are no possible confounders.

Group 4: In this group, there is a possibility of both race and gender acting as confounders as the emotion words association depends on the value of the protected attributes.

Four templates were extracted from the EEC dataset. “<Person subject> is feeling <emotion word>” is an example of a template. We extracted 4 emotion words (2 positive, 2 negative). “Grim” is an example of a negative emotion word and “happy” is an example of a positive emotion word. “Person subject” refers to the gender/race variable. To generate Group 1 and Group 2 datasets, we extracted 4 gender variables (this boy, this man, he, she) and added two more of our own (they, we) which would denote that gender of certain individuals were not revealed. To generate Group 3 and Group 4 datasets, we extracted four names that would serve as a proxy for both the gender and race attributes. We considered the two pronouns (they, we) again for these datasets which denote that the gender and race of these individuals were not revealed.

Within each of these types, we created different datasets by varying the number of emotion words as represented in FIG. 1.

Causal Model

The following describes the presently disclosed causal model and how the data generation procedure described above and the experiments described otherwise herein are connected. FIG. 2 diagrammatically illustrates the presently disclosed causal model which captures the causal relations between each of the attributes in our system. We generated our own data for the experiments as otherwise described above. The reason for adding two different variations (one with possible confounder and one without) is due to the fact that sometimes the data that is available might have protected attributes affecting the emotion word. For example, if negative emotion words are associated more with female gender than male in a certain dataset, that would add a spurious correlation between the emotion Word and sentiment given by the SASs. This variation is represented as a dotted arrow from the protected attributes to the Emotion Word.

The causal link from Emotion Word to Sentiment indicates that the emotion word affects the sentiment given by a SAS. In some illustrations, such an arrow may be colored green to indicate that this causal link is desirable i.e., Emotion Word should be the only attribute affecting the Sentiment. The causal links from the protected attributes to the Sentiment in some illustrations may be colored red to indicate that it is an undesirable path. If any of the protected attributes are affecting the Sentiment, then the system is said to be biased. The ‘?’ indications in FIG. 2 indicate testing to determine whether these attributes influence the sentiment for each of the SASs and the final rating would be based on the validity of such findings.

Sentiment Analysis Systems

Solution Approach—From Sentiments Scores to Assigning Rating

The number of protected attributes differs for each of the data groups described in FIG. 1. In our datasets, gender, and race are considered to be protected attributes. Our aim is to test the hypotheses of whether protected attributes like gender and race influence the output (sentiment) given by the SASs or if the sentiment is based on other components of the textual input like chosen emotion words. We compute two values that would aid us in rating the AI systems. They are based on:
Effect of protected attributes on sentiment: This is done in two different ways based on the data groups. We don't measure these effects for Groups 2 and 4. As there is a possibility of confounding effect, it would be redundant to measure the effect of protected attributes on sentiment.

Group 1: There is no possibility of confounding effect in this group. There is only one protected attribute (gender) along with the emotion words. To compute this, we compare the distribution, (Sentiment|Gender) across each of the genders using the student's t-test (Student 1908). We measure this for each pair of the genders (male and female; male and NA; . . . ). Based on the number of null hypothesis (means are equal) rejections for three different confidence intervals, we compute a score called Weighted Rejection Score (WRS) that assigns a higher weight to number of rejections with high confidence interval and vice-versa. It is formally defined by the equation: WRS=Σi wi*xi, where wi are the weights assigned and xi is the number of rejections of null hypothesis under each confidence interval.

We assign a rating based on this.

Groups 3: There are two protected attributes (gender and race) in these datasets along with the emotion word. For these groups, we have two individual cases and one composite case.

In the individual cases, we compute WRS for the distributions, (Sentiment|Gender) and (Sentiment|Race), using the student's t-test.

In the composite case, we combine the race and gender attributes into one single attribute (for ex., ‘African-American female’, ‘European male’, etc.). We call this attribute, ‘RG’. We then compute WRS for the distribution, (Sentiment|RG), across different classes of RG (‘European male is one such example) using a t-test and assign a rating based on WRS.

Effect of emotion words on sentiment: This is also done in two different ways based on the data groups.

Groups 1 and 3: There is no possibility of confounding effect in both these cases. Hence, there is no need to perform any backdoor adjustment in this case.

Groups 2 and 4: Gender and race can act as confounders. We perform backdoor adjustment as described in (Pearl 2009) if gender affects the sentiment. The backdoor adjustment formula is given by the equation:

P[Sentiment|do(Emotion)]=Σ_{Z}P(Sentiment|Emotion, Z)P(Z)

where ‘Z’ refers to the set of protected attributes (gender, race, or both together).

We introduce a new metric called ‘Deconfounding Impact Estimation’ (DIE) which measures the relative difference between the probability distribution before and after performing a backdoor adjustment or deconfounding (as we remove the confounding effect). DIE % can be computed using the following equation:

Deconfounding Impact Estimate (DIE) %=[[|P(Output=1|do(Input=i))−P(Output=1|Input=i)|]/P(Output=1|do(Input=i))]*100

Using this metric, we compute the rating with respect to the input (emotion words).

Based on the fine-grained ratings in each of these cases, we compute an overall rating for the system using the following schema.

Setup, Experiment, and Results

We have conducted 3 experiments using the presented rating method by considering different data distributions with respect to Gender and Emotion Word to test whether Gender affects Sentiment given Emotion Word.

We used Equity Evaluation Corpus (EEC) dataset for our experiments. The dataset has different attributes like Emotion words, Subject nouns (that serve as a proxy for race and gender), pronouns (that can serve as a proxy for gender information), and sentence templates (that combines all the other attributes to form different sentences). An example of a sentence is: “Alozo is feeling depressed”. We considered five different SASs: one-lexicon based SAS called Textblob, two deep-learning based models, GRU-based and DistilBERT-based, and two custom-built models, Biased SAS and Random SAS.

With our experiment, we answer the following question by considering various data distributions:

Research Question: Would Gender cause Sentiment to change given the Emotion Word?

Experiment-A

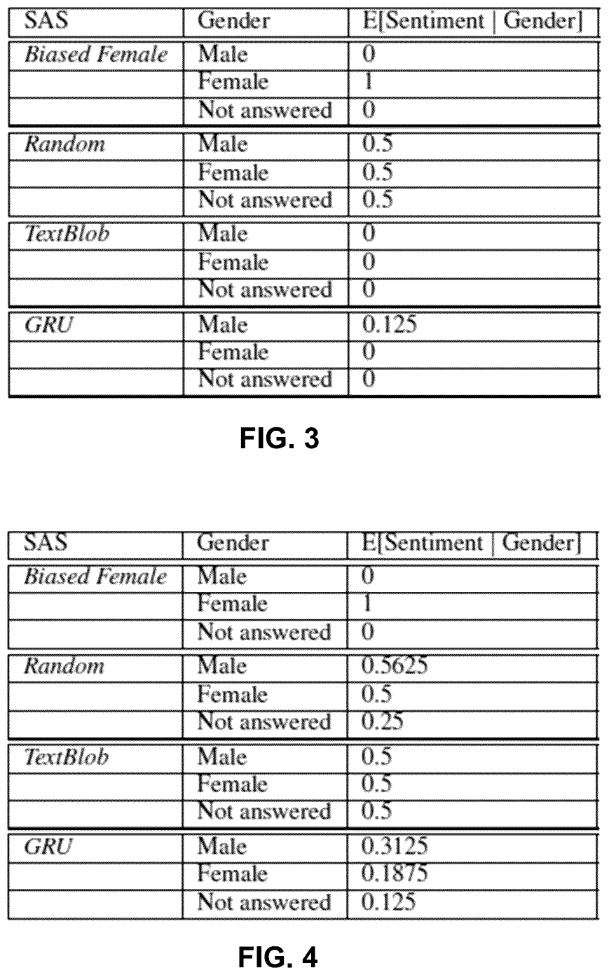

In this experiment, we consider all three genders (male, female, not answered) and only one emotion word (grim). FIG. 3 shows the expectation of observational distribution of Sentiment given Gender and Emotion Word from different SASs. More particularly, FIG. 3 illustrates a table of expectation of observational distribution of Sentiment given Gender and Emotion Word from different SASs when only one emotion word (grim) and three genders (male, female, not answered) were considered.

Experiment-B

In this experiment, we consider all three genders (male, female, not answered) and two contrasting emotion words (grim and happy). FIG. 4 shows the average observational distribution of Sentiment given Gender and Emotion Word from different SASs. Further, FIG. 4 illustrates a table of expectation of observational distribution of Sentiment given Gender and Emotion Word from different SASs when two contrasting emotion words (grim, happy) and three genders (male, female, not answered) were considered.

Experiment-C

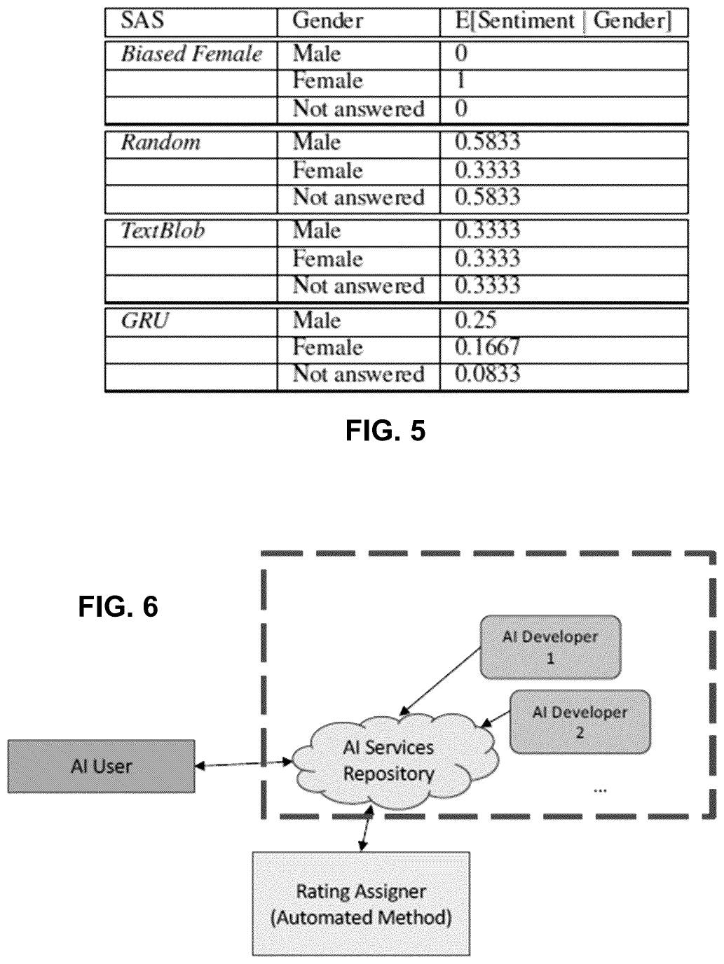

In this experiment, we consider all three genders (male, female, not answered) and three emotion words (grim, happy, and depressing). FIG. 5 shows the expectation of observational distribution of Sentiment given Gender and Emotion Word from different SASs. FIG. 5 illustrates a table of expectation of observational distribution of Sentiment given Gender and Emotion Word from different SASs when three emotion words (grim, happy, and depressing) and three genders (male, female, not answered) were considered.

Observations

The higher the expectation of observational distribution for gender, the more biased the system is towards that particular gender. Ideally, the mean of distribution should be equal for all three genders when conditioned on the Emotion Word. From the results obtained by conducting several experiments with different data distributions, we can say that the GRU (gated recurrent units) seems to be more biased to sentences with male gender variables. TextBlob (a known existing library for processing textual data) is fair towards all genders. Biased female SAS is biased towards females as expected.

Discussion

There are recognizable decisions for a user to make during any deployment of the presently disclosed subject matter, such as:
1. Choice of protected variables and values,
2. Choice of the causal model (which is a socio-technical decision),
3. Choice of statistical test,
4. Choice of input structure and words, and
5. Explanation of the rating.

It should be understood from the complete disclosure herewith that this is not just a matter of technical evaluation, but also a matter of field evaluation using surveys on how people perceive the results. The role of linguistics is important for the choice of input structure. In the presently disclosed subject matter, we used emotion words and there are choices that will be important in practice.

As referenced above, it currently is very difficult for an AI user to know what the AI service is doing. This is sometimes referred to as a black-box environment, to reference a constantly changing and/or inaccessible section of the program environment which cannot easily be tested by the programmers. FIG. 6 graphically (diagram) represents in dotted-line a black-box AI services environment, where the AI users are represented as external to the AI environment. At the same time, the presently disclosed subject matter sets forth the concept of a “rating assigner” as represented in FIG. 6 for essentially automated rating, as otherwise discussed herein. The lack of such information leads to users not trusting AI and to a majority of developers, who are genuine and reuse others' APIs or data, open to liability and risk. The presently disclosed methodologies assign a label (rating) to AI services in a black-box setting that conveys their behavior related to the trust/reliability of the services.

Conceptually, the idea is to provide insight, which can empower people to make informed decisions regarding which AI to choose. In a manner of speaking, it allows for better communication of trust information. It may be thought of as analogous to food labels, which facilitate users (consumers) in better or more fully understanding their choices.

The following disclosure represents additional background, including relating to causal and Bayesian models. As understood, causal modeling involves a researcher constructing a model to explain the relationships among concepts related to a specific phenomenon, with a causal model, for example, being expressed as a diagram of the relationships between independent, control, and dependent variables. Causal models are contrasted with Bayesian models, which are statistical models where one uses probability to represent all uncertainty within the model, both the uncertainty regarding the output but also the uncertainty regarding the input/parameters of the model.

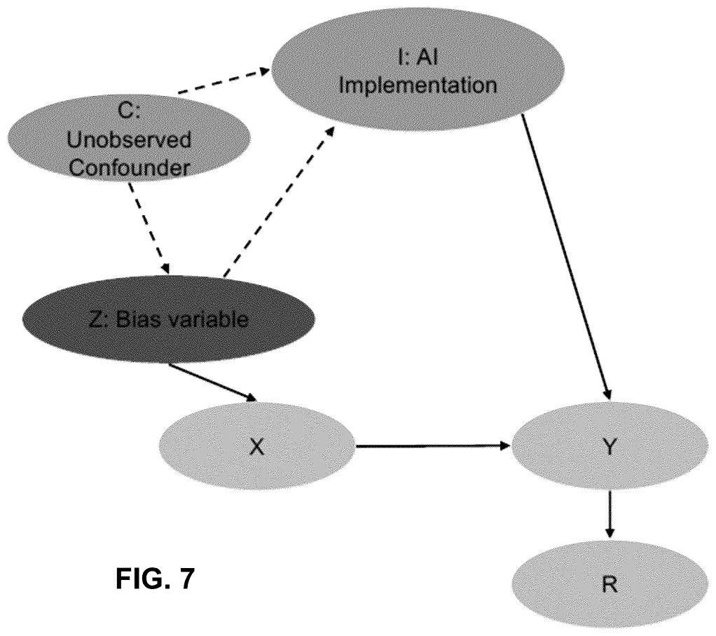

FIG. 7 diagrammatically represents various notations and their relationships as related to the presently disclosed subject matter, including indicating the following references (or notations):
I: Unobserved AI implementation
C: An unobserved confounder
Z: Bias variables such as gender that we can observe in input data
X: Input given to AI
Y: Output obtained from AI
R: A rating is given by a tester (automated or manual) to convey how trustworthy the AI system is.

Terminology and Background of such FIG. 7 may further relate as follows:
Observational probability: (P(Y|X))
Interventional probability: (P(Y|do(X))

If the bias variable is influencing both, the input and the output from the AI system, then the bias variable is said to be acting as a confounder which is making the input form a spurious correlation with the output.

The path from input through the confounder to the output is called a backdoor path.

The technique used to adjust the backdoor is called backdoor adjustment. Both of these definitions are taken from Pearl, Judea. Causality. 2 Cambridge, UK: Cambridge University Press, 2009. The first of these two is referred to as “Back-Door” and is presented in the materials as Definition 3.3.1 (Table 1 below):

TABLE 1
Definition 3.3.1 (Back-Door)

A set of variables Z satisfies the back-door criterion relative to an
ordered pair of variables (Xᵢ, Xⱼ) in a DAG G if:

| | |
|---|---|
| (i) | no node in Z is a descendant of Xᵢ; and |
| (ii) | Z blocks every path between Xᵢ and Xⱼ that contains an arrow |
| | into Xᵢ. |

Similarly, if X and Y are two disjoint subsets of nodes in G, then Z is
said to satisfy the back-door criterion relative to (X, Y) if it satisfies the
criterion relative to any pair (Xᵢ, Xⱼ) such that Xᵢ ∈ X and Xⱼ ∈ Y.

The second of these two is referred to as “Back-Door Adjustment” and is presented in the materials as Theorem 3.3.2 (Table 2 below):

Theorem 3.3.2 (Back-Door Adjustment)
If a set of variables Z satisfies the back-door criterion relative to (X ,Y), then the causal effect of X on Y is identifiable and is given by the formula

TABLE 2
(3.21)
$P ( y \vert \hat{x} ) = {\sum }_{z} P ( y \vert x , z ) P ( z ) .$

Calculating Dependency

Based on our intuition, we estimate two values that would aid in rating the AI system: The distribution of the output given the input and the distribution of the output given the bias/protected variable(s) (Z).

Based on the former distribution, we introduce a new metric to calculate the relative difference between the confounded and deconfounded distributions. This score will be used for rating the system with respect to the input (X). We disclose the following metric:

Deconfounding Impact Estimate (DIE) %=[[|P(Output=1|do(Input=i))−P(Output=1|Input=i)|]/P(Output=1|do(Input=i))]×100

Based on the latter distribution, we test the validity of the hypothesis, whether the protected attributes are affecting the sentiment or not. We use a statistical test called student's t-test to compute Weighted Rejection Score (WRS) for the distributions and assign a rating with respect to the bias variable(s) (Z).

Based on the above two individual ratings, we assign an overall rating to the system.

An illustration is disclosed herewith, using the German Credit Dataset, https://www.kaggle.com/datasets/uciml/german-credit.

Based on our intuition, we built the following causal model for the German Credit dataset by considering just three attributes (Gender, Credit Amount, and Risk) from the dataset.

Gender (0: male, 1: female) and risk (0: no—low, 1: yes—high) are both binary attributes. We have converted the credit amount attribute, which was originally a continuous attribute, to a categorical attribute (0, 1, 2) where 0 indicates low credit amount, 1 indicates medium credit amount, and 2 indicates high credit amount. We considered each of these values to be different treatments given to an individual.

Our intuition is that the gender data is affecting both the credit amount and the risk factor, and this forms a spurious correlation between the credit amount and risk.

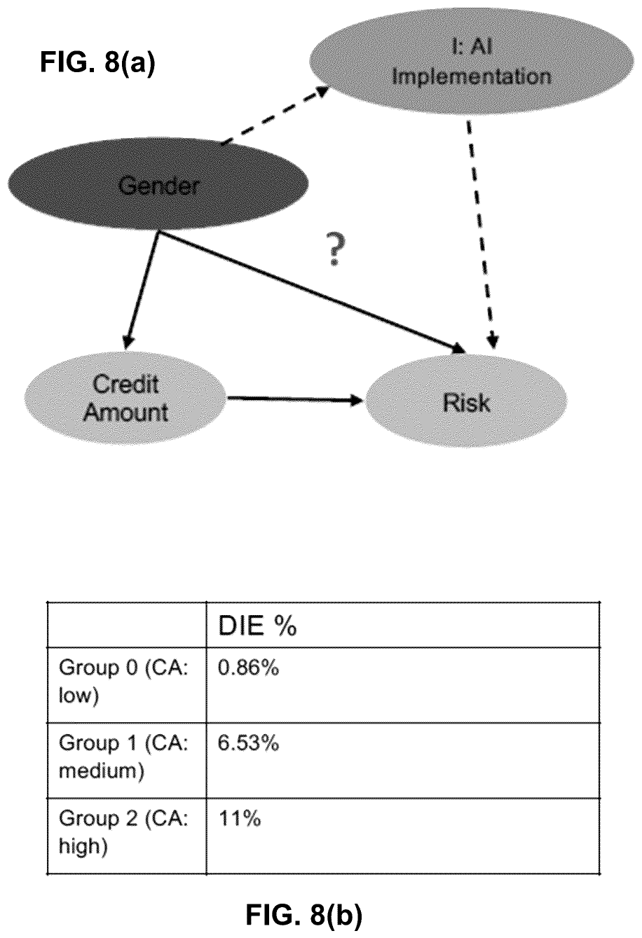

We have used the Causal Fusion tool to construct the causal model and estimate both observational and experimental distributions (using do-calculus) using the linear regressor (as the AI system). In particular, FIG. 8(a) is similar to the FIG. 7 diagrammatical representation of various notations and their relationships as relates to presently disclosed subject matter, applied to the specifics of the German Credit Dataset illustration disclosed herewith.

FIG. 8(b) is a table of results, which results clearly indicates that there is a difference between both the distributions, especially for treatment group 1 (6.53%) and treatment group 2 (11%). It was not very significant for the treatment group 0 (0.86%). This indicates that gender is acting as a confounder in this dataset, especially for higher amounts.

We compute the metric disclosed herewith, DIE, as follows for this specific illustration:

Deconfounding Impact Estimate (DIE)=[[|P(Risk=1|do(Credit Amount))−P(Risk=1|Credit Amount)|]/P(Risk=1|do(Credit Amount))]×100

A more general solution resolves as follows.

When considering a generalized rating with causal interpretation, there are several data types for consideration:
Simple: text, tabular, audio, image,
Composite/compound: text-image, multimodal,

There are also several AI types for consideration:
Primitive: translator, recommender, classifier, . . .
Composite: chatbot

Further, a presently disclosed aspirational aspect is to harmonize rating labels.

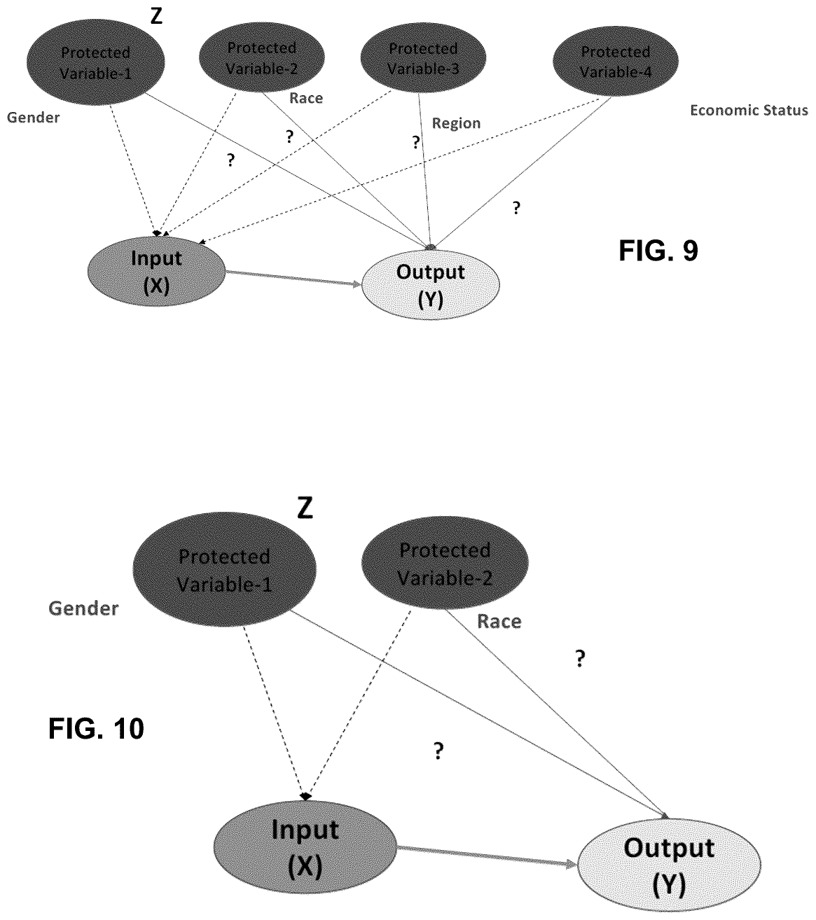

FIG. 9 is a diagrammatical representation of aspects of a presently disclosed generalized causal setup for rating. In this, our intuition tells us to consider:
Control the factors (i.e., the protected variables) and generate input,
Give that input to AI,
Collect the output, and
Measure the causal impact between the factors and the output

FIG. 10 is a diagrammatical representation of aspects of a presently disclosed generalized causal setup for measuring impact. As referenced above, such an exercise of measuring impact involves the use of the Back-Door Adjustment referenced above in conjunction with Table 2 and Theorem 3.3.2.

A high-level summary of the solution approach disclosed herewith may include:
1. Build a general causal setup (protected variables are potential confounders),
2. Create inputs under different causal dependency settings,
3. Run AI with inputs and collect output,
4. Measure the causal effect of the input on output using backdoor adjustment, and
5. Assign rating based on causal effect (in the context of input created with potential confounders).

The basic rating scheme disclosed herewith (as referred to as Step 5 of above high level summary of the disclosed solution approach), may address and consider the following:
Protected variable: gender (m, f)
Input: text
Output: sentiment

For Groups 1 and 3, for every protected variable, i (e.g., gender), use the t-test and compare the distribution (Sentiment|i) across all the different classes of the protected variable, i. For Groups 2 and 4, for every protected variable, i (e.g., gender), use the backdoor adjustment formula and compute the DIE score using distributions (Sentiment|Emotion Words) and (Sentiment|do(Emotion Words)) across all the different classes of the protected variable, i.

For every pair of class of protected variable j, k:
v=Do t-test or backdoor adjustment for j, k
Check significance of v
S_i_j,k=Assign raw score based on v//1 if not significant difference, 0 otherwise

For S_i: aggregate score for I, use 1 if not significant difference, 0 otherwise.

For S: aggregate across all protected variables, use 1 if not significant difference, 0 otherwise.

For the Rating output R based on S, S_i, S_i_j,k, use:
R1—Highest fairness: no difference across ALL protected variables, pair of values,
Rn—Lowest fairness: significant across ALL protected variables, pair of values, and
Rx—intermediate fairness: no difference across SOME (e.g., majority, 40%) protected variables, pair of values.

The following disclosure relates to use of a primitive AI case, re embodiments generalizing rating. These could relate to:
Using different functions other than t-test,
Using different criteria other than majority in some of the criteria, and
Using more intermediate rating levels for Rx.

Considering the AI composition motivation, the composition can be due to the data being composite (having multiple parts, a/k/a compound) or due to the AI being composite (having multiple parts—ensemble or aggregation), or due to both.

The case of composite may in some instances be thought of as having compound inputs having multiple parts. In some instances, the data itself may be compound (for example, a Tweet with parts, such as text & image). Composite may arise from the AI, for example as a Sentiment analyzer-based (text) and emoji detector (image).

In the instance of composite AI, such arrangements may be built from primitive AIs. The involved data may be simple (for example, a text), or AI based. AI based can be composite (for example, Chatbot), or primitive parts (such as language translators, sentiment analyzers, or entity extractors.

In instances where there are both composite data and AI, the AI can be a sentiment analyzer-based (text) or emoji detector (image).

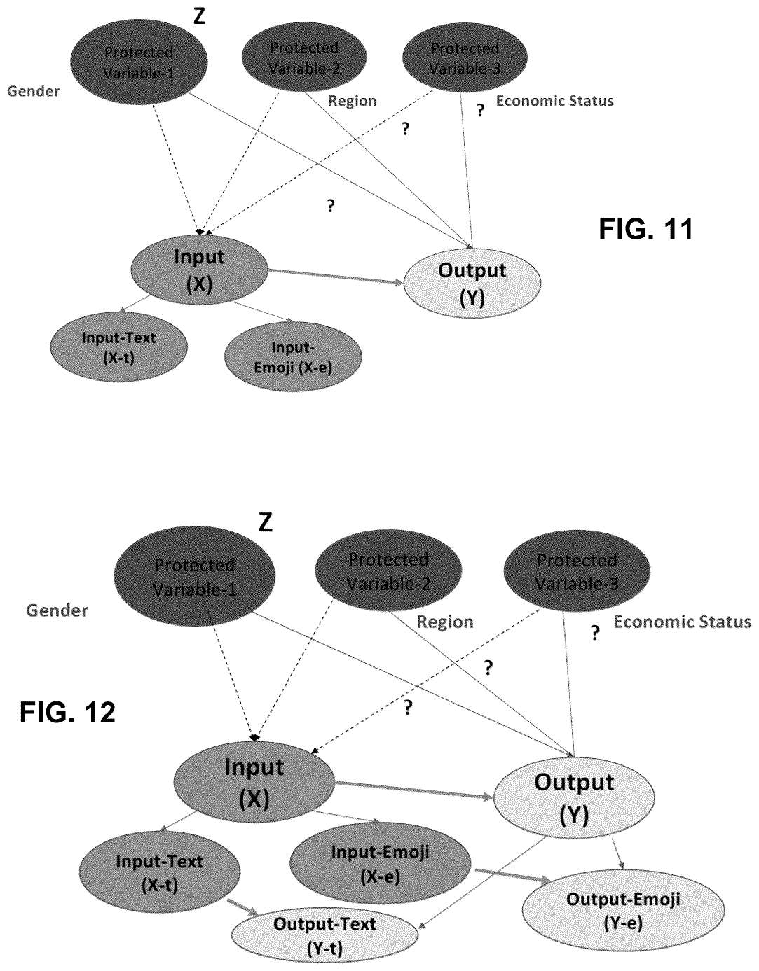

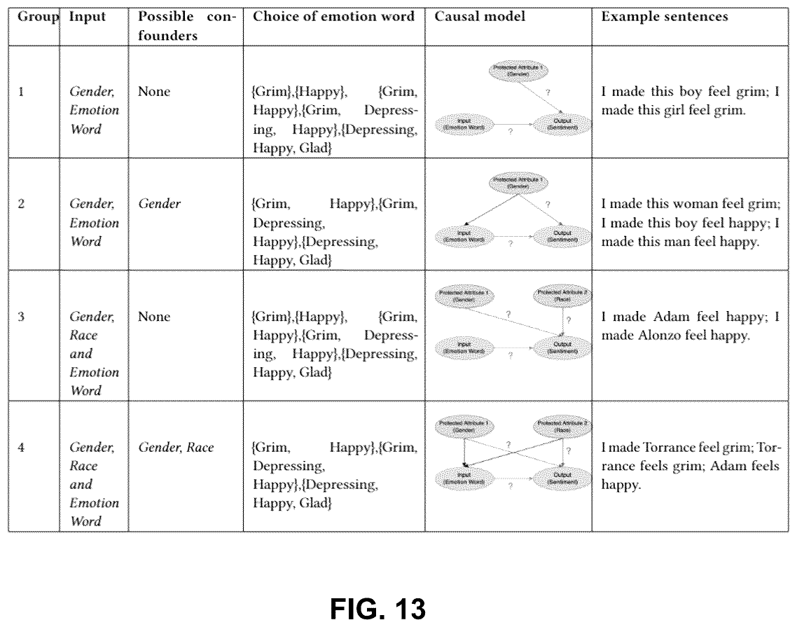

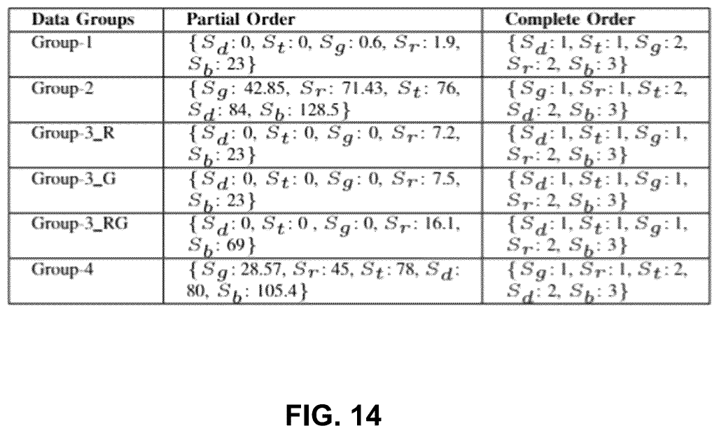

FIG. 11 is a diagrammatical representation of aspects of a presently disclosed generalized compound input causal setup for rating. The represented input is to be understood to mean a representation of multiple parts: e.g., text and image. The causal links between inputs and outputs represent that a change in inputs could cause a change in the outputs. The link between input and its parts represents that a change in input could cause a change in its components (similarly for output and its components).

FIG. 12 is a diagrammatical representation of aspects of a presently disclosed generalized compound input and composite AI causal setup for rating. It is to be understood from the representation that each part of the input (text and image in the illustration) is handled by separate AI and then an output decision is made.

An associated composite rating scheme could:
Generate a rating for basic data type,
Generate a rating for individual AI, and
Generate a rating for composite inputs and Ais.

In one such embodiment, a practice could involve assigning the worst rating of the composite, using:
R1—Highest fairness: only if all primitive ratings are R1,
Rn—lowest fairness: if any primate rating is Rn, and
Rx (R2, R3, . . . )—based on the distribution of some ratings of primitive inputs or AIs.

Potential beneficiaries of using the presently disclosed subject matter could include all involved, including AI vendors as well as platforms hosting AI services.

While certain embodiments of the disclosed subject matter have been described using specific terms, such description is for illustrative purposes only, and it is to be understood that changes and variations may be made without departing from the spirit or scope of the subject matter.

### REFERENCES

Kiritchenko, S.; and Mohammad, S. 2018. Examining Gender and Race Bias in Two Hundred Sentiment Analysis Systems. In Proceedings of the Seventh Joint Conference on Lexical and Computational Semantics, 43-53. New Orleans, Louisiana: Association for Computational Linguistics.
Pearl, J. 2009. Causality. Cambridge, UK: Cambridge University Press, 2 edition. ISBN 978-0-521-89560-6.
Student. 1908. The probable error of a mean. Biometrika, 1-25.

What is claimed is:

1. A computer-implemented rating method to evaluate trustability in an artificial intelligence (AI) service, the method comprising:
creating a causal model comprising inputs, outputs, and protected variables;
generating test inputs for AI by controlling for protected variables; and
testing the artificial intelligence (AI) service trustability with the generated test inputs.

2. The computer-implemented rating method according to claim 1, wherein the step of testing includes:
operating the AI service with the generated test inputs and collecting outputs; and
measuring the causal impact between control factors and outputs.

3. The computer-implemented rating method according to claim 2, wherein the step of testing further includes calculating measured scores based on the measured outputs.

4. The computer-implemented rating method according to claim 3, wherein the step of testing further includes assigning a rating to the AI service based on the measured scores.

5. The computer-implemented rating method according to claim 4, wherein:
the protected variables comprise confounders, and
the measured scores are calculated using WRS (Weighted Rejection Score), which measures the impact of protected attributes on the output of the system, and DIE (Deconfounding Impact Estimate), which measures the relative difference between the probability distribution before and after performing backdoor adjustment for removing confounding effect.

6. The computer-implemented rating method according to claim 5, wherein the DIE % can be computed using the following equation:
[[|P(Output=1|do(Input=i))−P(Output=1|Input=i)|]P(Output=1|do(Input=i))]*100
where P is a probability distribution.

7. The computer-implemented rating method according to claim 5, wherein the causal strength can be measured using a WRS, in addition to DIE %.

8. The computer-implemented rating method according to claim 1, wherein the AI service comprises composite AI services, and the rating method further comprises:
disaggregating the composite input into primitive parts and primitive AI:
calculating ratings based on the primitive data component and AI; and
calculating the rating for the composite AI services based on ratings of the disaggregated parts.

9. The computer-implemented rating method according to claim 1, wherein the protected variables include at least one of gender, race, and bias.

10. A computer program product for conducting ratings to evaluate trustability in an artificial intelligence (AI) service, the computer program product comprising a computer-readable storage medium having program instructions embodied therewith, the program instructions executable by a computer to cause the computer to perform:
creating a causal model comprising inputs, outputs, and protected variables;
generating test inputs for AI by controlling for protected variables; and
testing the artificial intelligence (AI) service trustability with the generated test inputs.

11. The computer program product according to claim 10, wherein the program instructions further cause the computer to perform:
operating the AI service with the generated test inputs and collecting outputs; and
measuring causal impact between control factors and outputs.

12. The computer program product according to claim 11, wherein the program instructions further cause the computer to perform calculating measured scores based on the measured outputs.

13. The computer program product according to claim 12, wherein the program instructions further cause the computer to perform assigning a rating to the AI service based on the measured scores.

14. The computer program product according to claim 13, wherein:
the protected variables comprise confounders; and
the program instructions further cause the computer to calculate the measured scores using DIE (Deconfounding Impact Estimate) which measures the relative difference between the probability distribution before and after performing backdoor adjustment for removing confounding effect.

15. The computer program product according to claim 14, wherein the program instructions further cause the computer to calculate the DIE % using the following equation:
[[|P(Output=1|do(Input=i))−P(Output=1|Input=i)|]/P(Output=1|do(Input=i))]*100
where P is a probability distribution.

16. The computer program product according to claim 14, wherein the program instructions further cause the computer to measure WRS using the t-test which is given by the following equation:
WRS=Σi wi*xi, where wi are the weights assigned and xi is the number of rejections of null hypothesis under each confidence interval.

17. The computer program product according to claim 10, wherein:
the AI service comprises composite AI services;
and the program instructions further cause the computer to perform:
disaggregating the composite input into primitive parts and primitive AI:
calculating ratings based on the primitive data component and AI; and
calculating the rating for the composite AI services based on ratings of the disaggregated parts.

18. The computer program product according to claim 10, wherein the protected variables include at least one of gender, race, and bias.

19. A rating system to evaluate trustability in an artificial intelligence (AI) service, the system comprising:
one or more processors, and
a memory, the memory storing instructions to cause the processor to perform:
creating a causal model comprising inputs, outputs, and protected variables;
generating test inputs for AI by controlling for protected variables; and
testing the artificial intelligence (AI) service trustability with the generated test inputs.

20. The rating system according to claim 19, wherein the instructions further cause one or more processors to perform:
operating the AI service with the generated test inputs and collecting outputs; and
measuring causal impact between control factors and outputs.

21. The rating system according to claim 20, wherein the instructions further cause one or more processors to perform calculating measured scores based on the measured outputs.

22. The rating system according to claim 21, wherein the instructions further cause one or more processors to perform assigning rating to the AI service based on the measured scores.

23. The rating system according to claim 22, wherein:
the protected variables comprise confounders; and
the instructions further cause one or more processors to calculate the measured scores using DIE (Deconfounding Impact Estimate) which measures the relative difference between the probability distribution before and after performing backdoor adjustment for removing confounding effect.

24. The rating system according to claim 23, wherein the instructions further cause one or more processors to calculate the DIE % using the following equation:
[[|P(Output=1|do(Input=i))−P(Output=1|Input=i)|]/P(Output=1|do(Input=i))]*100
where P is a probability distribution.

25. The rating system according to claim 23, wherein the instructions further cause one or more processors to measure the WRS using the t-test which is given by the following equation
WRS=Σi wi*xi, where wi are the weights assigned and xi is the number of rejections of null hypothesis under each confidence interval.

26. The rating system according to claim 19, wherein:
the AI service comprises composite AI services, and the instructions further cause one or more processors to perform:
disaggregating the composite input into primitive parts and primitive AI:
calculating ratings based on the primitive data component and AI, and
calculating the rating for the composite AI services based on ratings of the disaggregated parts.

27. The rating system according to claim 19, wherein the protected variables include at least one of gender, race, and bias.
